(19) United States
(12) Patent Application Publication
(10) Pub. No.: US 2006/0194107 A1
(43) Pub. Date: Aug. 31, 2006

(54) Silver manganese salt cathodes for alkali

(75) Inventor: Stuart Licht, Technion City (IL)

Correspondence Address: BROWDY AND NEIMARK, P.L.L.C.;624 NINTH STREET, NW, SUITE 300, WASHINGTON, DC, 20001-5303, US

(73) Assignee: Chemergy, Energy Technologies, Technion City (IL)

(21) Appl. No.: 11/223,137

(22) Filed: Sep. 12, 2005

Related U.S. Application Data
(63) Continuation of application No. 10/076,268, filed on May 13, 2002, now abandoned.

(30) Foreign Application Priority Data
Feb. 20, 2001 (IL) 141527

(51) Int. Cl. H01M 4/54; H01M 4/50; H01M 4/62

(52) U.S. Cl. 429/219; 429/224; 429/232

(57) ABSTRACT

An electric storage alkaline battery comprising an electrically neutral alkaline ionic conductor, an anode and a cathode, whereby electric storage is accomplished via electrochemical reduction of the cathode and oxidation of the anode, whereby said cathode includes electrochemically active silver (per)manganate materials.

The present invention relates to electric storage batteries. More particularly, the invention relates to a novel alkaline electric storage battery with a cathode formed from a silver manganese compound.

### BACKGROUND OF THE INVENTION

MnO₂ is the common active cathode material in primary alkaline batteries. As an alternative to MnO₂, a variety of permanganate compounds have been considered for cathode materials due to their high oxidation state which, in principle permits significant storage and release of electrical charge. However, as described by J. Epstein and C. C. Liang, U.S. Pat. No. 3,799,959 (Oct. 12, 1971), most permanganates salts are overly soluble in alkaline solution and this solubility can be destructive to the battery performance. In addition, most permanganate salts do not discharge effectively in the solid phase, although as described by S. Licht and C. Marsh, U.S. Pat. No. 5,549,991, (Aug. 27, 1996), in the solution phase they can support high currents.

Compared to the manganese dioxide alkaline cathode reaction, both manganates and permanganates can have a significantly higher faradaic capacity and higher cathodic potential. The thermodynamic potential for the 1e⁻ permanganate to manganate reduction in aqueous alkaline media is:
MnO₄⁻+1e−→MnO₄²⁻ E=0.56V vs SHE (1)
and manganate also can exhibit a direct discharge to manganese dioxide, summarized as the 2e⁻ reduction:
MnO₄⁻+2H₂O+3e⁻→MnO₂+4OH⁻ E=0.58V vs SHE (2)
and alternately permanganate also can exhibit a direct discharge to manganese dioxide, summarized as the 3e⁻ reduction:
MnO₄²⁻+2H₂O+2e⁻→MnO₂+4OH⁻ E=0.58V vs SHE (3)
In addition, the MnO₂ product can undergo a further 1e− reduction, as utilized in the conventional commercial alkaline (Zn anode/MnO₂ cathode) cell:
2MnO₂+H₂O+2e⁻→Mn₂O₃+2OH⁻ E=0.35V vs SHE (4)

Manganate salts, being in the less oxidized manganese valence state of Mn(VI), will store less charge in principle, than the permanganates. This lower valence state would also suggest that they would be considered to be less chemically active. In principal, as described by equations 2 and 4, permanganate salts can undergo a total of a 4e⁻ alkaline cathodic reduction, and by equations 3 and 4 manganate salts can undergo a total of a 3e⁻ alkaline cathodic reduction. Yet the manganate and permanganate salts have not replaced the widely used commercial alkaline MnO2 cathode due to a general perception that these salts are too soluble (creating a tendency to react and decompose the anode), and that they exhibit only inefficient, and/or low current density, charge transfer.

The absorbance spectra and Xray diffraction of AgMnO₄ has been characterized [W. P. Doyle, I. Kirkpatrick, Spectrochimica Acta, 24A (1968) 1495]. AgMnO₄ is not a traditional Mn(VII) permanganate salt and the manganese evidently exists in a valence state between VI and VII, while the silver exists in a valence state between I and II [L. F. Mehne, B. B. Wayland, J. Inorg. Nucl. Chem., 37 (1975) 1371]. In principle, this silver (per)manganate, AgMnO₄, represent a substantial cathodic charge source for electrochemical storage, but high rate charge transfer has been inefficient. Independent of whether AgMnO₄ is described as silver permanganate, Ag(I)Mn(VII)O₄, or silver peroximanganate, Ag(II)Mn(VI)O₄, or as a mixed intermediate valence, where 0<x<1) for Ag(I+x)Mn(VII-x)O₄, AgMnO₄, can in principal provide a higher cathodic charge capacity than other permanganate or manganate salts. In addition to the manganese reduction, AgMnO₄ permits the alkaline reduction, as Ag(I) (or if Ag(MnO₄)₂ had been used as Ag(II)) in the same potential domain, and exemplified by the silver oxide reductions:
Ag₂O+H₂O+2e⁻→2Ag+2OH⁻ E=0.35V vs SHE (5)
2AgO+H₂O+2e⁻→Ag₂O+2OH⁻ E=0.57V vs SHE (6)
Hence, independent of the Ag(I)/Mn(VII) or Ag(II)/Mn(VI) starting point, the alkaline cathodic reduction AgMnO₄ is consistent with an overall 5 electron reduction to Ag(0) and Mn(III) at thermodynamically potential, E≧0.35V vs SHE, for example as:
AgMnO₄+5/2H₂O+5e⁻<Ag+½Mn₂O₃+5OH⁻ E>0.35V vs SHE (7)

It is an object of the present invention to provide an additive to the cathode in alkaline batteries which provides a practical storage capacity greater than the capacity known for conventional cathode materials. A novel electrochemically active solid cathode is demonstrated using silver permanganate.

### BRIEF DESCRIPTION OF THE INVENTION

The invention relates to an electrical storage cell, so-called alkaline battery, comprising two half-cells which are in electrochemical contact with one another through an electrically neutral alkaline ionic conductor, wherein one of said half-cells comprises an anode and the other half-cell comprises a cathode, whereby electrical storage is accomplished via electrochemical reduction of the cathode and oxidation of the anode. The cathode contains an electrochemically active silver manganate, or silver permanganate compound, or oxidized silver and manganate or permanganate material.

### BRIEF DESCRIPTION OF THE FIGURES

FIG. 1 is a diagrammatic illustration of the silver (per)manganate material cathode battery according to the invention; and

FIGS. 2 to 8: illustrate graphically performance of various battery aspects according to the invention as described in the Examples.

### DETAILED DESCRIPTION OF THE INVENTION

The novel battery according to the present invention is based on the addition of an electrochemically active silver manganate material or silver permanganate material to form a cathode in an alkaline battery, as silver (per)manganate and hydroxide. In one embodiment the hydroxide is in the form of a salt solid. In a preferred embodiment the solid hydroxide comprises at least 1% of the weight of the cathode mass. In other embodiments, the solid hydroxide comprises at least 5% or 25% of the weight of the cathode mass. In a preferred embodiment the silver (per)manganate is in the form of AgMnO₄, or in an alternate embodiment is in the form of Ag(MnO₄)₂, or in an alternate preferred embodiment is formed from the mixture of silver salt, and a (per)manganate salt other than silver (per)manganate. In this alternate preferred embodiment, said silver salt is AgO, or in alternate embodiments, said silver salt is AgNO₃, a silver halide, Ag₂O, AgOH, Ag₂O₂, or Ag(OH)₂. In this alternate preferred embodiment said (per)manganate salt other than silver is a manganate salt such as BaMnO₄, MgMnO₄, CaMnO₄, SrMnO₄, K₂MnO₄, Na₂MnO₄, Li₂MnO₄, Rb₂MnO₄, Cs₂MnO₄, ammonium manganate, or a tetra alkyl ammonium manganate, and in another alternate embodiment is a permanganate salt such as KMnO₄, NaMnO₄, LiMnO₄, RbMnO₄, CsMnO₄, ammonium permanganate, or a tetra alkyl ammonium permanganate.

The phrase “theoretical charge capacity” refers to the calculated charge capacity of that cathode material in accord with the known number of faradays (moles electrons) stored per mole of that material. The theoretical charge capacity is calculated through equation 8 and where n is the number of discharge electrons, F is the Faraday's constant=26.801 Amp hour per mol, and Fw is the formula weight:
Theoretical charge capacity=n×F/Fw (9)

For any specified known cathode material, discharged at low current density rate, the phrase “conventional cathode storage capacity” is specifically the theoretical charge capacity of that cathode material. At higher rates of current density, this “conventional cathode storage capacity” is less than the theoretical charge capacity, and refers to the maximum amount of cathode storage capacity previously attainable for the cathode material at this discharge condition. Table 1 presents the theoretical storage capacity of various cathode materials calculated in accord with equation 2 through 8.

The anode of the battery may be selected from the known list of metals capable of being oxidized, typical such as zinc, cadmium, lead, iron, aluminum, lithium, magnesium, calcium; and other metals such as copper, cobalt, nickel, chromium, gallium, titanium, indium, manganese, silver, cadmium, barium, tungsten, molybdenum, sodium, potassium, rubidium and cesium.

The anode may also be of other typical constituents capable of being oxidized, examples include, but are not limited to hydrogen, (including but not limited to metal hydrides), inorganic salts, and organic compounds including aromatic and non-aromatic compounds. The anode may also be of other typical constituents used for lithium-ion anodic storage, examples include, but are not limited to lithium-ion in carbon based materials and metal oxides.

TABLE 1
Theoretical charge capacity of several known cathode materials,
determined with equation 2

| | | | Fw | Charge capacity |
|---|---|---|---|---|
| cathode material | cathode name | n | kg/mole | Amp hour/kg |
| MnO₂ | manganese dioxide | 1 | 86.9 | 308 |
| NiOOH | nickel oxyhydroxide | 1 | 91.7 | 289 |
| HgO | mercury oxide | 2 | 216.6 | 247 |
| Ag₂O | silver oxide | 2 | 231.7 | 231 |
| AgO | silver peroxide | 2 | 123.9 | 433 |
| AgMnO₄ | silver(I) manganate | 5 | 226.8 | 591 |
| Ag(MnO₄)₂ | silver permanganate | 10 | 345.7 | 775 |

The electrically neutral alkaline ionic conductor utilized in the battery according to the present invention, comprises a medium that can support current density during battery discharge in an alkaline medium. A typical representative ionic conductor is an aqueous solution preferably containing a high concentration of a hydroxide such as KOH. In other typical embodiments, the electrically neutral ionic conductor comprises a high concentration of NaOH.

An electric storage battery according to the invention may be rechargeable by application of a voltage in excess of the voltage as measured without resistive load, of the discharged or partially discharged cell.

According to another embodiment of the invention, means are provided to impede transfer of chemically reactive species, or prevent electric contract between the anode and cathode. Said means includes, but is not limited to a non-conductive separator configured with open channels, a membrane, a ceramic frit, grids or pores or agar solution; such means being so positioned as to separate said half cells from each other.

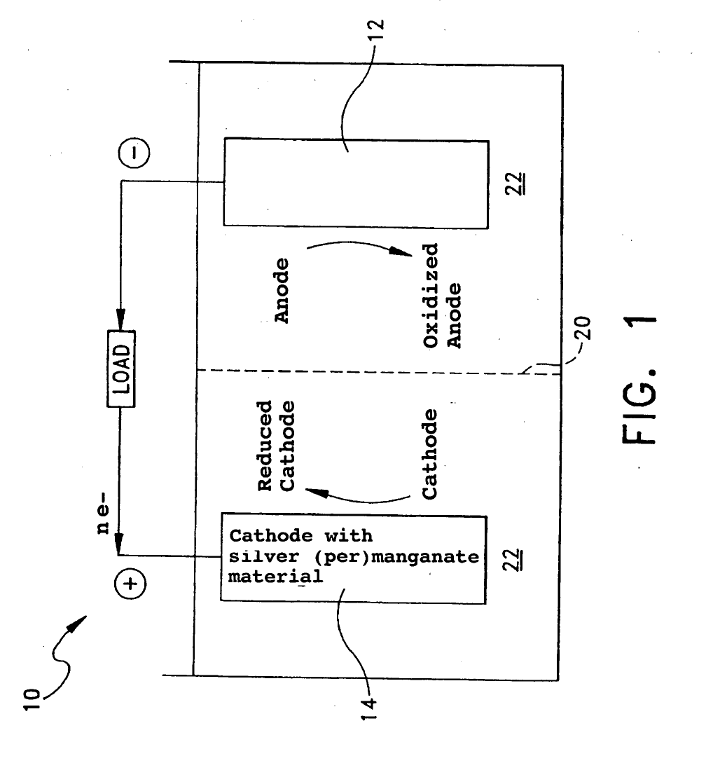

### DETAILED DESCRIPTION OF FIG. 1

FIG. 1 illustrates schematically an electrochemical cell 10 based on a cathode which contains a silver manganese compound half cell, an electrically neutral alkaline ionic conductor and an anode. The cell contains an electrically neutral alkaline ionic conductor 22, such as a concentrated aqueous solution of KOH, in contact with a cathode which contains a silver and manganese salt 14. Reduction of the cathode, is achieved via electrons available from the electrode 14. The anode electrode 12, such as in the form of metal is also in contact with the electrically neutral ionic conductor 22. Electrons are released in the oxidation of the anode. Optionally, the cell may contain a separator 20, for minimizing the non-electrochemical interaction between the cathode and the anode.

The invention will be hereafter illustrated in further detail with reference to the following non-limiting examples, it being understood that the Examples are presented only for a better understanding of the invention without implying any limitation thereof, the invention being covered by the claims. Although the examples used AAA cells, it will be appreciated by those skilled in the art that the increase in performance may be obtained regardless of the cell size. It will be understood by those who practice the invention and by those skilled in the art, that various modifications and improvements may be made to the invention without departing from the spirit of the disclosed concept.

### EXAMPLE 1

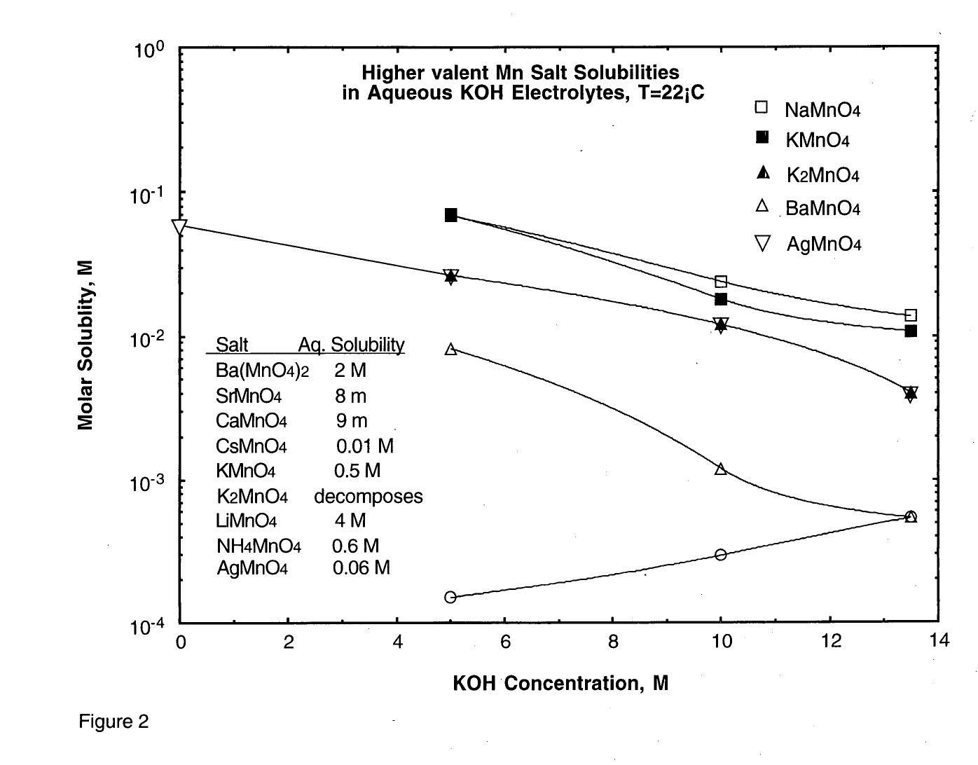

Salts which are less soluble are preferred as cathodic materials. In water the solubility of AgMnO₄ is relatively low (60 millimolar); eight fold less soluble than KMnO₄, 10 to 100 times less than lithium, sodium, ammonium, calcium, strontium and barium permanganates. In the storage cell, low solubility, or insolubility is preferred to minimize parasitic cathode/anode interactions. An experiment was carried out, the object being to demonstrate the low solubility of silver manganate in potassium hydroxide solutions of concentrations similar to those used in alkaline batteries. As measured in FIG. 2, the solubility of silver permanganate is very low compared to that of the other permanganate. As measured in FIG. 2, the solubility of silver permanganate is very low compared to that of most manganate salts, and is similar to the low solubility of potassium manganate salt.

### EXAMPLE 2

An experiment was carried out, the object being to demonstrate that the silver manganate, prepared as a cathode mix under the same conditions as the common permanganate salt, KMnO₄, discharges to a substantially higher fraction of it's theoretical cathodic charge, particularly when a hydroxide salt is added. Salts that can discharge to a higher percentage of their theoretical cathodic charge, are preferred as alkaline cathodic salts.

Cells are prepared with identical zinc anodes and separators, as removed from commercial AAA alkaline cells. Cell potential and energy capacity of alkaline AAA cells were measured during discharge at a constant load rate of 75 Ω. Cells contain either 3.4 g KMnO₄, or 4.6 g AgMnO₄ in the 9 weight percent graphite mix, and 9 weight percent 13.5 molar KOH electrolyte. In addition to these cells, those indicated as 32% graphite cathodes, contains 2.3 g KMnO₄, and 2.8 g AgMnO₄ in the respective cathode mixes. The sodium permanganate mix also includes solid NaOH to avoid an overly wet mixture, as well as 32 wt % graphite (2.1 g of NaMnO₄.H₂O and NaOH in a 9:1 weight ratio).

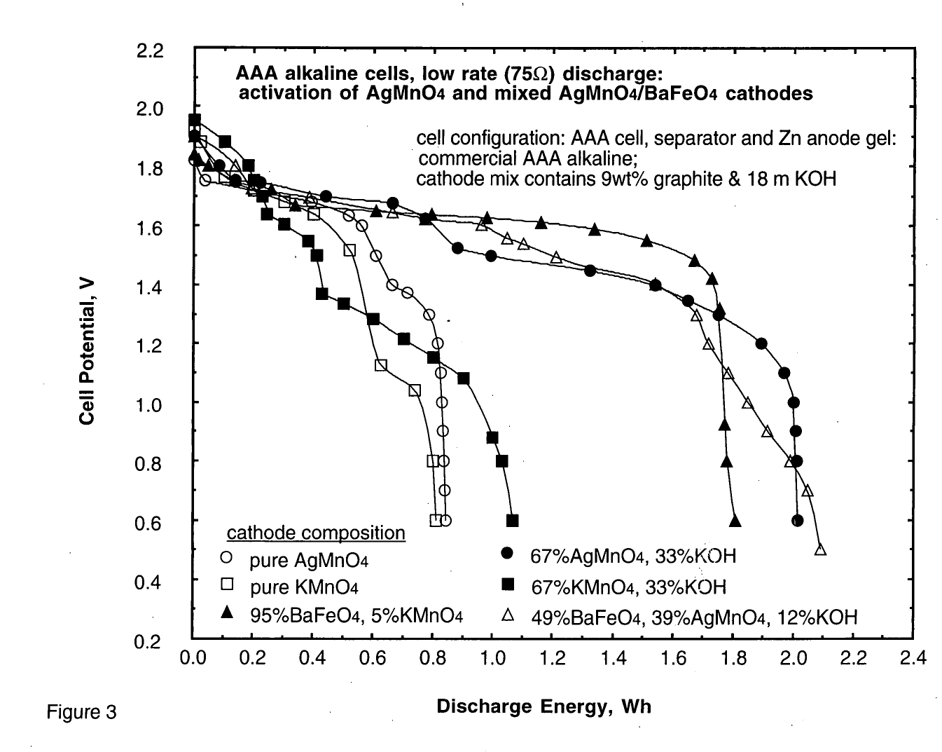

Permanganates and manganese salts represent a substantial source of cathodic charge, but discharge ineffectively in traditional alkaline batteries. As summarized in FIG. 3, a cathode consisting of KMnO₄ alone, or AgMnO₄ alone, or KMnO₄ and KOH together, discharge ineffectively in a conventional AAA cell configuration. In the same cell configuration the pure AgMnO₄ cathode discharges less effectively, than a pure manganate or pure potassium permanganate cathode. However, a cathode of AgMnO₄ and KOH together discharges effectively to a high discharge capacity of 2.0 Wh. Evidently the intimate mixture of these reaction products are substantially more electrochemical active than silver permanganate alone.

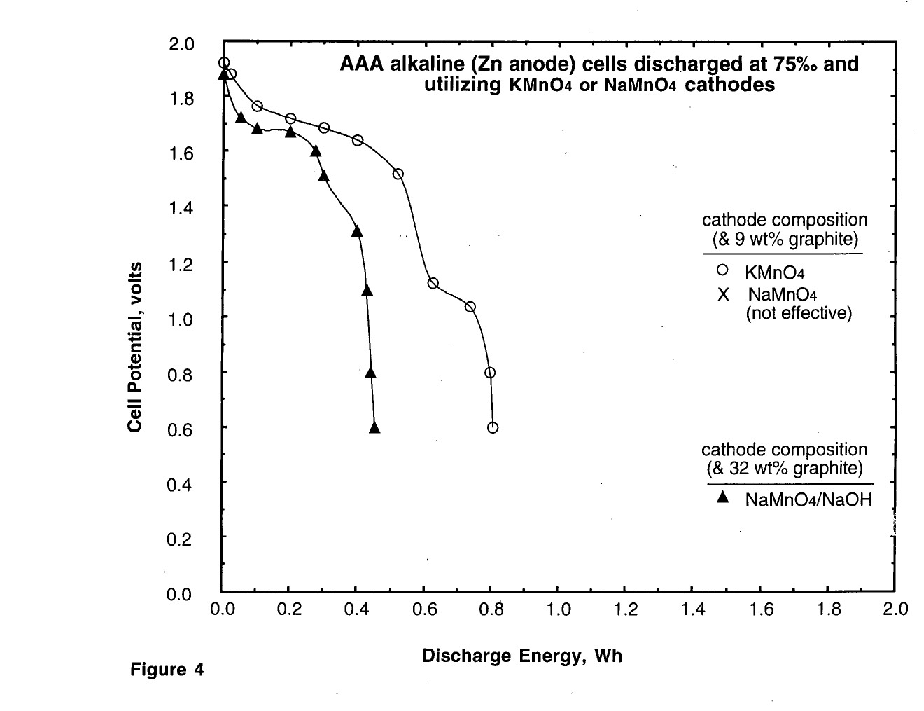

A cathode which discharges to a high total energy, is preferred. FIG. 4, presents the higher discharge energy measured for the silver manganate cathode, compared to a KMnO₄ cathode under the same conditions. The figure summarizes the measured discharge of NaMnO₄, or KMnO₄ compared to the AgMnO₄ cathode alkaline AAA cells. Despite the lower intrinsic Mn(VI→IV) capacity of the silver manganate salt, this salt's cathode approaches 1.0 Wh, yielding a higher discharge capacity than the sodium or potassium permanganate cathode cells. As is evident in the figure, the measured discharge capacity is higher, despite the lower intrinsic 4e⁻ capacities, for the heavier alkali cation permanganates compared to the lighter alkali permanganates. The measured capacity of sodium, and potassium permanganate cathodes is ˜0.45 Wh and 0.8 Wh. The sodium permanganate discharge required a higher fraction (32 weight percent) of graphite to generate a discharge.

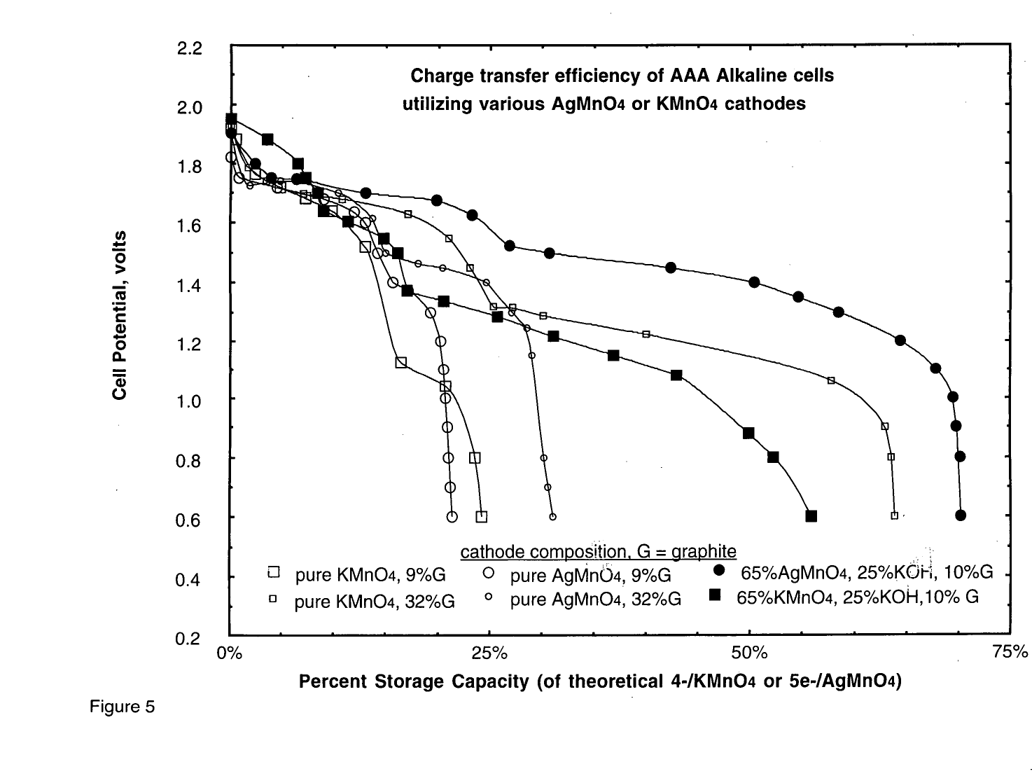

Compared to the AgMnO₄ cell, the pure KMnO₄ cathode cell in FIG. 2, exhibits a lesser, but significant, improvement with KOH addition. In the presence of KOH, this enhanced Mn(VII) charge transfer indicated for KMnO₄ containing KOH, is attributed to the improved conductive matrix that this Fe(VI) salt provides. The cathode reduction is supported by a conductive matrix provided through inclusion of graphite in the cathode mix. FIG. 5, probes the experimental 4e⁻ (for KMnO₄) or 5e⁻ (for AgMnO₄), efficiency, determined by comparison of the measured cumulative discharge ampere hours, as a fraction of the intrinsic charge determined from the mass of the salt. The Percent Storage Capacity is determined by the measured cumulative ampere hours, compared to the theoretical capacity. In this figure utilization of higher weight fraction (employing 32 weight percent, rather than 9 weight percent) graphite greatly improves the percent storage capacity of the KMnO₄, and withou being limited to any theory, reductive charge transfer appears to be significantly effected by an insufficient conductive matrix. This is not the case for the AgMnO₄ cathode which is already conductive, and as seen in FIG. 5, added graphite results only in a marginal improvement in storage efficiency. Silver, in addition, to being an excellent metallic conductor, sustains effective conductances of it's cations through it's oxides. As the AgMnO₄/KOH discharges, the concentration of reduced silver grows and provides a growing conductive matrix to increasingly facilitate the manganese reduction. In the more efficient KOH activated AgMnO4 discharge, distinct voltage plateaus are observed in FIG. 5 at 1.7 and 1.5 volts, equivalent to approximately one third and two thirds of the discharge. Each of these potential steps is presumably a mixed potential related to portions of the overall 5 electron transfer.

FIG. 5, shows that silver manganate, prepared as a cathode mix under the same conditions as the common permanganate salts, KMnO₄, discharges to a substantially higher fraction of it's theoretical cathodic charge. Under these conditions, and as seen in the figure middle, a cathode comprised of only KMnO₄, exhibits less than half of the capacity of the AgFeO₄ cathode.

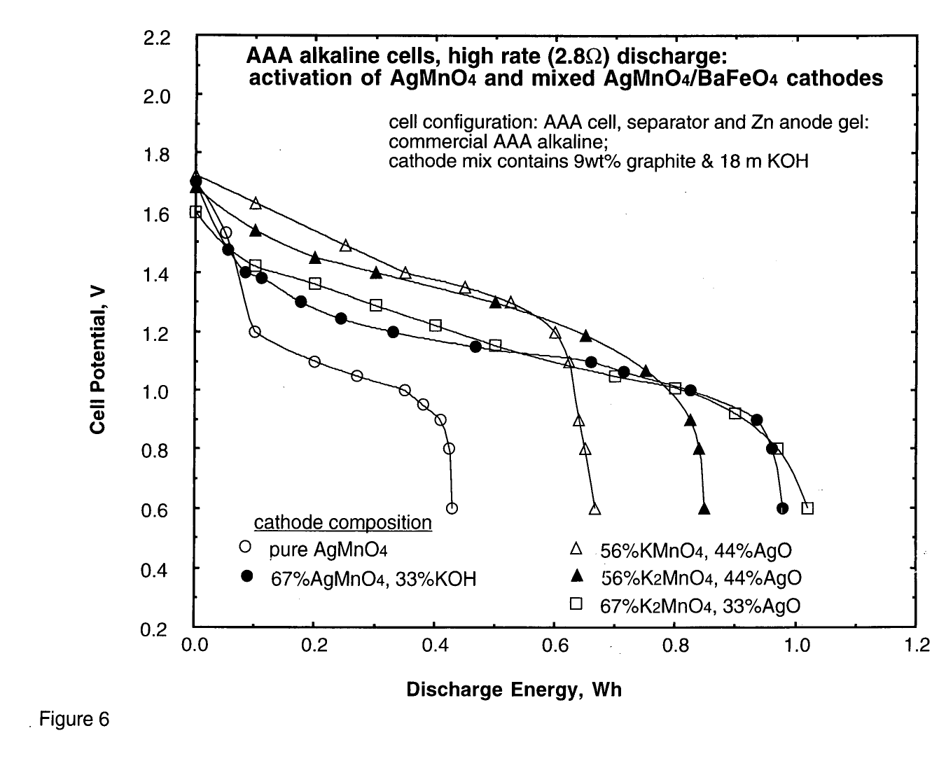

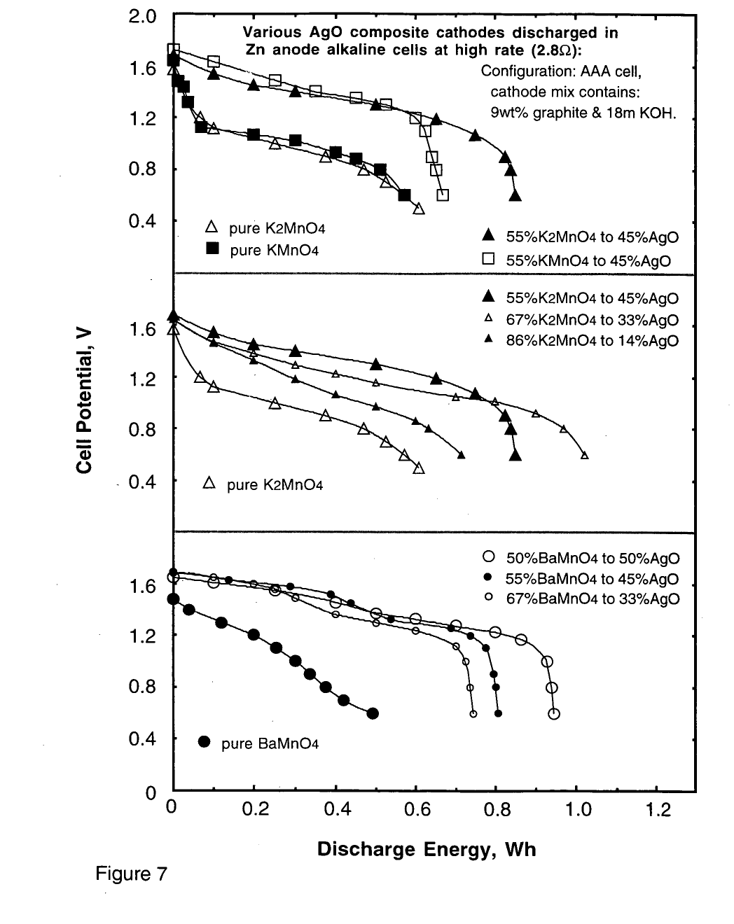

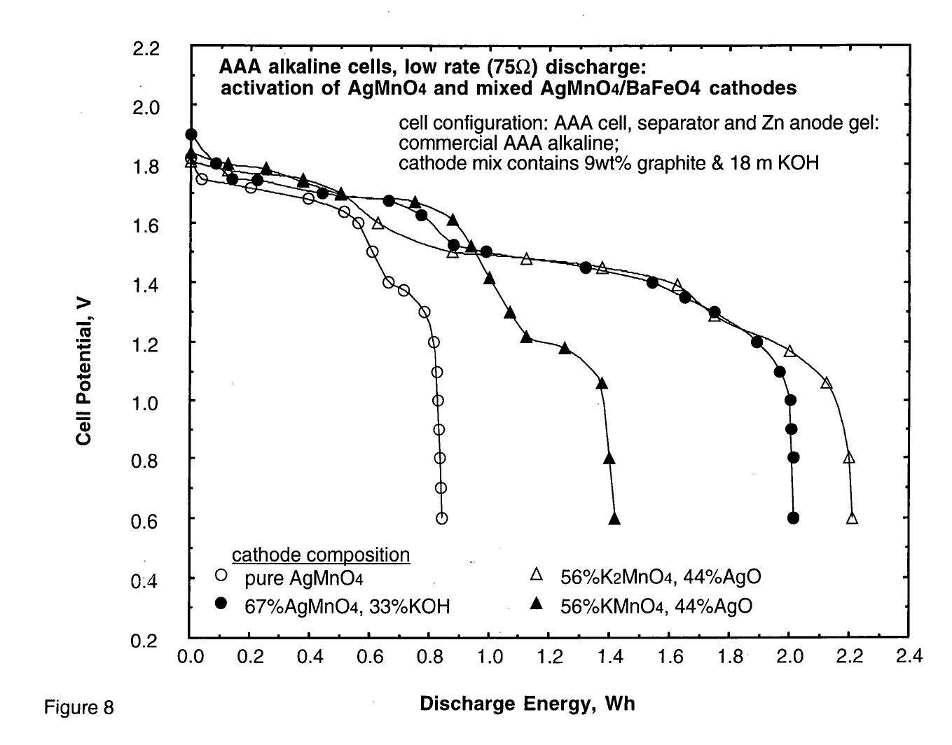

FIGS. 6 and 7 demonstrate that for the high rate discharge domains, accomplished by discharging the cells over a constant 2.8Ω load, the KOH activated AgMnO₄ cathode discharges more effectively than the pure AgMnO₄, or other manganate or permanganate cathodes alone. This figures also demonstrates that mixtures of other manganate or permanganate cathodes with AgO discharges in a manner similar to the hydroxide activated AgMnO₄ cathodes. This is also demonstrate for the low rate discharge domain, in FIG. 8.

### EXAMPLE 3

An experiment was carried out, the object being to demonstrate that the silver permanganate cathode can also be used in combination with other cathode salts. AgMnO₄ mixed with a Fe(VI) salt cathode discharges effectively as an alkaline cathode. FIG. 2, also includes the discharge of alkaline cells with a mixed cathode which includes the Fe(VI) salt, BaFeO₄, and silver permanganate, and it is evident that the mixed AgMnO₄/Fe(VI) cathode can also attain a high discharge capacity of 2.0 Wh.

### EXAMPLE 4

In an alternate configuration Ag(MnO₄)₂ can also be used as an alkaline cathode. We find by spectral analysis that Ag(MnO₄)₂ is formed by the mixture of AgMnO₄ and oxidizing agent, or the mixture of a permanganate salt other than AgMnO₄, a silver salt, other than AgMnO₄, and an oxidizing agent.

1. A battery comprising two half-cells which are in an electrochemical contact with one another through an electrically neutral alkaline ionic conductor, wherein one of said half-cells comprises an anode and the other half-cell comprises a cathode, whereby electrical discharge is accomplished via reduction of the cathode and oxidation of the anode, and whereby said cathode includes silver (per)manganate salt and hydroxide.

2. The battery according to claim 1 whereby said silver (per)manganate is in the form of AgMnO₄.

3. The battery according to claim 1 whereby said silver (per)manganate is in the form of Ag(MnO₄)₂.

4. The battery according to claim 1 whereby said silver (per)manganate is formed from the mixture of silver salt, and a (per)manganate salt other than silver (per)manganate.

5. The battery according to claim 4 whereby said silver salt is AgNO₃, or AgNO₂

6. The battery according to claim 4 whereby said silver salt is a silver halide, silver halate, silver perhalate, or silver halite.

7. The battery according to claim 4 whereby said silver salt contains carbon, from the salt list of silver acetate, silver carbonate, silver fulimate, silver lactate, silver acetylide, silver levunilate, silver oxalate, silver palimate, silver cyanate, silver thiocyanate, silver benzoate, silver propionate, silver salicyate, silver stearate or silver tartrate.

8. The battery according to claim 4 whereby said silver salt is chosen from the list of silver tetraborate, silver sulfate, silver thiosulfate, silver dithionate, silver selenate, silver selinide, silver telluride, silver tungstate, silver azide, silver phosphate, silver orthophosphate or silver pyrophosphate.

9. The battery according to claim 4 whereby said silver salt is a silver oxide.

10. The battery according to claim 6 whereby said silver oxide, is Ag₂O or AgOH.

11. The battery according to claim 4 whereby said silver salt is a silver peroxide.

12. The battery according to claim 4 whereby said silver peroxide is AgO.

13. The battery according to claim 12 whereby said silver peroxide is Ag₂O₂ or Ag(OH)₂.

14. The battery according to claim 4 whereby said (per)manganate salt other than silver is a manganate salt.

15. The battery according to claim 14 whereby said manganate salt is a K₂MnO₄.

16. The battery according to claim 14 whereby said manganate salt is a BaMnO₄.

17. The battery according to claim 14 whereby said manganate salt is MgMnO₄, CaMnO₄, SrMnO₄, K₂MnO₄, Na₂MnO₄, Li₂MnO₄, Rb₂MnO₄, Cs₂MnO₄, ammonium manganate, or a tetra alkyl ammonium manganate.

18. The battery according to claim 4 whereby said (per)manganate salt other than silver is a permanganate salt.

19. The battery according to claim 18 whereby said permanganate salt is a KMnO₄.

20. The battery according to claim 18 whereby said permanganate salt is NaMnO₄, LiMnO₄, RbMnO₄, CsMnO₄, ammonium permanganate, or a tetra alkyl ammonium permanganate.

21. The battery according to claim 4 whereby said mixture also includes an oxidizing agent.

22. The battery according to claim 7 whereby said oxidizing agent is a hypochlorite salt.

23. The battery according to claim 7 whereby said oxidizing agent is a peroxydisulfate salt.

24. The battery according to claim 1 whereby said silver permanganate comprises at least 1% of the weight of the cathode mass.

25. The battery according to claim 1 whereby said silver permanganate comprises at least 5% of the weight of the cathode mass.

26. The battery according to claim 1 whereby said silver permanganate comprises at least 25% of the weight of the cathode mass.

27. The battery according to claim 1 whereby said hydroxide comprises a solid salt.

28. The battery according to claim 1 whereby said hydroxide salt is potassium hydroxide.

29. The battery according to claim 27 whereby said hydroxide salt comprises at least 1% of the weight of the cathode mass.

30. The battery according to claim 27 whereby said hydroxide salt comprises at least 5% of the weight of the cathode mass.

31. The battery according to claim 27 whereby said hydroxide salt comprises at least 25% of the weight of the cathode mass.
